(19) United States
(12) Patent Application Publication
(10) Pub. No.: US 2026/0156282 A1
(43) Pub. Date: Jun. 4, 2026

(54) WAVERESNEXT ARCHITECTURE FOR LEARNED IMAGE COMPRESSION

(71) Applicant: Samsung Electronics Co., Ltd., Suwon-si (KR)

(72) Inventors: Indranil Sinharoy, Richardson, TX (US); Saifeng Ni, Santa Clara, CA (US); Madhukar Budagavi, Plano, TX (US); Rajan Laxman Joshi, San Diego, CA (US)

(21) Appl. No.: 19/401,276

(22) Filed: Nov. 25, 2025

Related U.S. Application Data
(60) Provisional application No. 63/727,528, filed on Dec. 3, 2024.

(51) Int. Cl. H04N 19/436; H04N 19/12; H04N 19/124; H04N 19/13; H04N 19/63

(52) U.S. Cl. CPC H04N 19/436; H04N 19/12; H04N 19/124; H04N 19/13; H04N 19/63

(57) ABSTRACT

Methods and systems for learned image compression using a WaveResNeXt architecture. A method includes receiving an image and mapping the image to a latent representation using an encoder with parallel processing layers. The method also includes generating a quantized representation by quantizing the latent representation using a hyper encoder. The method further includes generating a bitstream by encoding the quantized representation using entropy encoding. The method then includes mapping the latent representation to a hyperprior representation to generate a hyper latent representation. The method additionally includes generating a quantized hyper latent representation by quantizing the hyper latent representation. The method also includes decoding the bitstream using a decoder based on the quantized hyper latent representation to generate a reconstructed image.

### CROSS-REFERENCE TO RELATED APPLICATIONS AND CLAIM OF PRIORITY

The present application claims priority to U.S. Provisional Patent Application No. 63/727,528, filed on Dec. 3, 2024. The contents of the above-identified patent documents are incorporated herein by reference.

### TECHNICAL FIELD

The present disclosure relates generally to image processing systems. more specifically, the present disclosure relates to a system and method for learned image compression using a WaveResNeXt architecture.

### BACKGROUND

Contemporary high-performance learned image and video compression (LIVC) methods often exhibit prohibitive computational complexity, which has impeded industry adoption despite their superior compression performance relative to state-of-the-art traditional techniques.

Moreover, many LIVC architectures utilize variational autoencoder (VAE)-based networks for the system's transform-coding components. Recent studies have shown that although these networks substantially reduce spatial redundancy in the two-dimensional input signal, residual frequency-domain correlations persist that can be further leveraged through explicit frequency-domain processing modules.

Accordingly, there is a need for systems and methods for improved learned image compression systems and methods that overcome these challenges.

### SUMMARY

The present disclosure relates generally to wireless communication systems and, more specifically, the present disclosure relates to a system and method for learned image compression using a WaveResNeXt architecture.

In one embodiment, a method is provided. The method includes receiving an image and mapping the image to a latent representation using an encoder with parallel processing layers. The method also includes generating a quantized representation by quantizing the latent representation using a hyper encoder. The method further includes generating a bitstream by encoding the quantized representation using entropy encoding. The method then includes mapping the latent representation to a hyperprior representation to generate a hyper latent representation. The method additionally includes generating a quantized hyper latent representation by quantizing the hyper latent representation. The method also includes decoding the bitstream using a decoder based on the quantized hyper latent representation to generate a reconstructed image.

In another embodiment, an electronic device is provided. The electronic device includes memory and a processor operably coupled to the memory. The processor is configured to receive an image and map the image to a latent representation using an encoder with parallel processing layers. The processor is also configured to cause the electronic device to generate a quantized representation by quantizing the latent representation using a hyper encoder. The processor is further configured to cause the electronic device to generate a bitstream by encoding the quantized representation using entropy encoding. The processor is then configured to cause the electronic device to map the latent representation to a hyperprior representation to generate a hyper latent representation. The processor is additionally configured to cause the electronic device to generate a quantized hyper latent representation by quantizing the hyper latent representation. The processor is also configured to cause the electronic device to decode the bitstream using a decoder based on the quantized hyper latent representation to generate a reconstructed image.

In yet another embodiment, a non-transitory computer-readable medium is provided. The non-transitory computer-readable medium includes program code, that when executed by at least one processor of an electronic device, causes the electronic device to receive an image and map the image to a latent representation using an encoder with parallel processing layers. The non-transitory computer-readable medium includes program code, that when executed by the at least one processor, also causes the electronic device to generate a quantized representation by quantizing the latent representation using a hyper encoder. The non-transitory computer-readable medium includes program code, that when executed by the at least one processor, further causes the electronic device to generate a bitstream by encoding the quantized representation using entropy encoding. The non-transitory computer-readable medium includes program code, that when executed by the at least one processor, additionally causes the electronic device to map the latent representation to a hyperprior representation to generate a hyper latent representation. The non-transitory computer-readable medium includes program code, that when executed by the at least one processor, then causes the electronic device to generate a quantized hyper latent representation by quantizing the hyper latent representation. The non-transitory computer-readable medium includes program code, that when executed by the at least one processor, also causes the electronic device to decode the bitstream using a decoder based on the quantized hyper latent representation to generate a reconstructed image.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with an embodiment of this disclosure;

FIG. 2 illustrates an example electronic device in accordance with embodiments of the present disclosure;

FIG. 3 illustrates an example electronic device in accordance with embodiments of the present disclosure;

FIG. 4 illustrates an example learned image compression architecture in accordance with embodiments of the present disclosure;

FIG. 5 illustrates example learned image compression architecture in accordance with embodiments of the present disclosure;

FIG. 6 illustrates example residual layers for learned image compression in accordance with embodiments of the present disclosure;

FIG. 7 illustrates an example discrete wavelet transform filter with 1-level discrete wavelet transform for learned image compression in accordance with embodiments of the present disclosure;

FIG. 8 illustrates an example learned image compression architecture including WaveResNeXt layers in accordance with embodiments of the present disclosure;

FIG. 9 illustrates an example ResNeXt layer for learned image compression architecture of FIG. 8 in accordance with embodiments of the present disclosure;

FIG. 10 illustrates an example WaveResNeXt layer for learned image compression architecture of FIG. 8 in accordance with embodiments of the present disclosure;

FIGS. 11A-11B illustrate example discrete wavelet transform filters with 2-level discrete wavelet transform according to embodiments of the present disclosure; and

FIG. 12 illustrates an example flow chart of a method for learned image compression using a WaveResNeXt architecture according to embodiments of the present disclosure.

### DETAILED DESCRIPTION

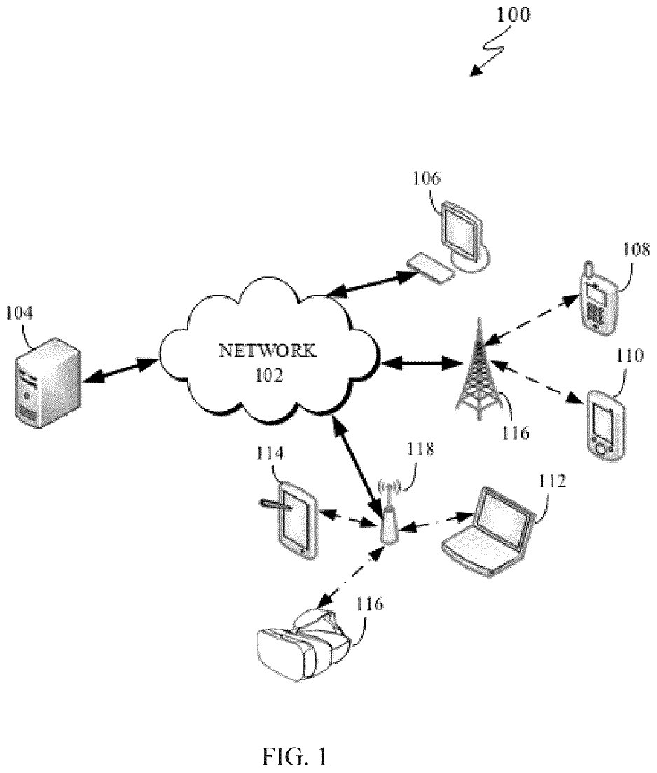

FIG. 1 through FIG. 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, contemporary high-performance learned image and video compression (LIVC) methods often exhibit prohibitive computational complexity, which has impeded industry adoption despite their superior compression performance relative to state-of-the-art traditional techniques.

Moreover, many LIVC architectures utilize variational autoencoder (VAE)-based networks for the system's transform-coding components. Embodiments of the present disclosure recognize that although these networks substantially reduce spatial redundancy in the two-dimensional input signal, residual frequency-domain correlations persist that can be further leveraged through explicit frequency-domain processing modules.

Accordingly, the present disclosure provides systems and methods for learned image compression using a WaveResNeXt architecture. As described herein, the present disclosure includes systems and methods that map an image to a latent representation using an encoder with parallel processing layers. A quantized representation is generated by quantizing the latent representation using a hyper encoder. A bitstream is generated by encoding the quantized representation using entropy encoding. The method then includes mapping the latent representation to a hyperprior representation to generate a hyper latent representation. The method additionally includes generating a quantized hyper latent representation by quantizing the hyper latent representation. The method also includes decoding the bitstream using a decoder based on the quantized hyper latent representation to generate a reconstructed image. The encoder, the decoder, the hyper encoder, and the hyper decoder include one or more parallel processing layers, such as one or more layers having ResNeXt architecture, a WaveResNeXt architecture, or a combination thereof. The present disclosure, thus, provides a set of modifications to current LIVC methods that either improve compression performance, such as measured by BD-rate reductions of at least 6%, or reduce computational complexity, while explicitly exploiting frequency-domain correlations to enhance coding efficiency.

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included a given device is increasing. Even with the increase of processing power portable electronic devices often struggle to provide the processing capabilities to handle new services and applications, as newer services and applications often require more resources that is included in a portable electronic device. Improved methods and apparatus for configuring and deploying media processing in the network is required.

Cloud media processing is gaining traction where media processing workloads are setup in the network (e.g., cloud) to take advantage of advantages of the benefits offered by the cloud such as (theoretically) infinite compute capacity, auto-scaling based on need, and on-demand processing. An end user client can request a network media processing provider for provisioning and configuration of media processing functions as required.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

FIG. 1 illustrates an example communication system 100 in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and an HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s).

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

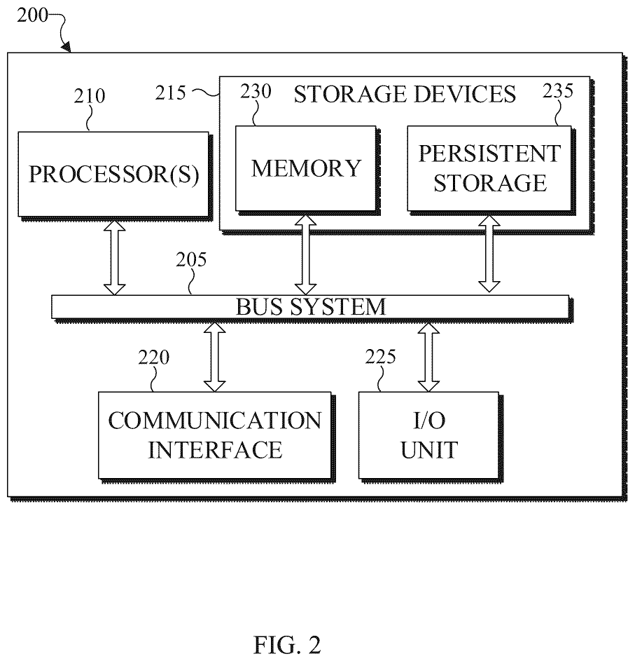

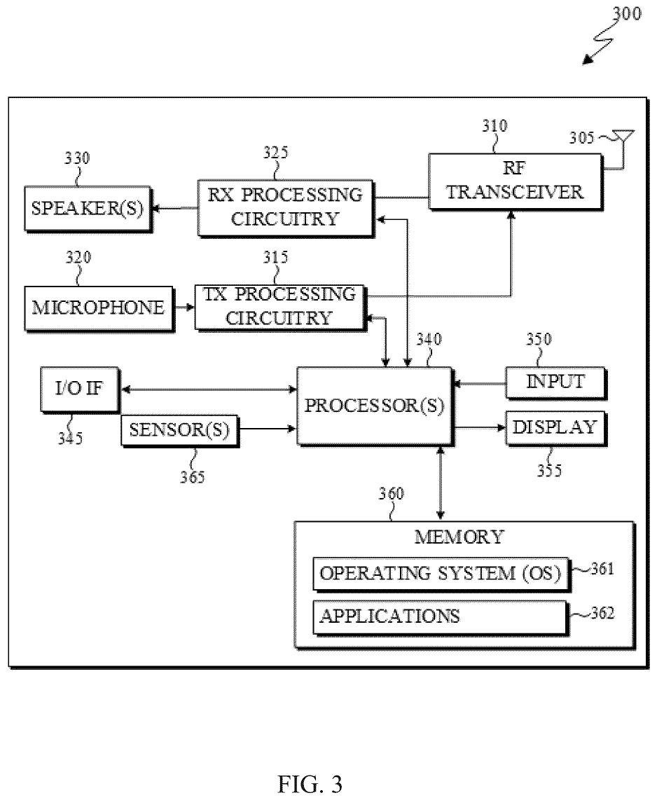

FIGS. 2 and 3 illustrate example electronic devices in accordance with an embodiment of this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106 116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within an HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

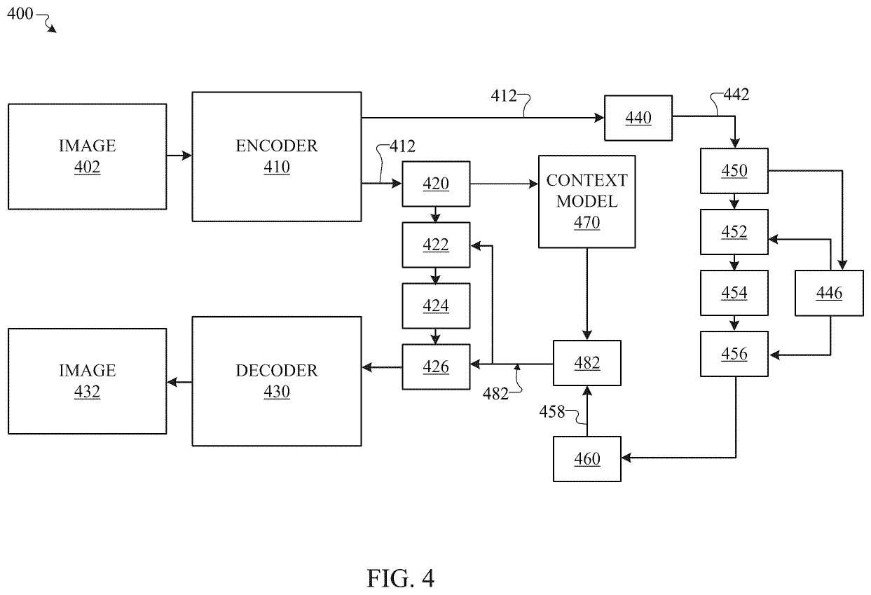

The processing circuitry of the client devices 106-116 may also include one or more image compression models configured to compress and reconstruct images obtained using the one or more sensors, such as the cameras or optical sensors. The one or more compression models may include learned image compression (LIC) models, as shown in FIGS. 4-12.

FIG. 4 illustrate an example learned image compression (LIC) architecture 400 according to embodiments of the present disclosure. For ease of explanation, the LIC architecture 400 will be described as including one or more components of the communication network 100 of FIG. 1, such as the client devices 106-116; however, the LIC architecture 400 could be implemented using any other suitable device or system. The embodiment of the LIC architecture 400 shown in FIG. 4 is for illustration only. Other embodiments of the LIC architecture 400 could be used without departing from the scope of this disclosure.

As shown in FIG. 4, the LIC architecture 400 includes an encoder 410 configured to receive an image 402. The encoder 410 is configured to generate latent representation 412 based on the image 402 and pass the latent representation 412 to a quantization portion 420. The quantization portion 420 quantizes the latent representation 412 and transmits the quantized latent representation 412 to an arithmetic encoder 422. The arithmetic encoder 422 generates a bitstream 424 based on the quantized latent representation 412. The bitstream 424 is then provided to an arithmetic decoder 426 before being provided to a decoder 430 to produce a reconstructed image 432 based on the image 402.

The encoder 410 is a parametric mapping function that transforms high-dimensional input observations into a compact latent representation 412 that captures the salient, task-relevant factors of variation. During training, the encoder 410 is optimized to produce latent variables that are both informative about the image 402 and amendable to the LIC architecture 400 downstream operations. For probabilistic formulations, the encoder 410 outputs sufficient statistics, such as means and variances, or logits used to define a discrete or continuous posterior over latents. The architecture of the encoder 410 determines which aspects of the image 402 are preserved in the latent space.

The quantization portion 420 converts the latent representation 412, such as continuous-valued latent outputs, into a discrete representation suitable for lossless storage or transmission. The quantization of the latent representation 412 allows the latent representation 412 to be used by channels in the LIC architecture 400. The quantization portion 420 may quantize the latent representation 412 using, for example, uniform rounding, vector quantization, learned codebooks, or stochastic quantization. The chosen desired quantization method affects the reconstruction error, codebook use, and how well the entropy model can predict symbol frequencies.

The arithmetic encoder 422 performs arithmetic encoding, a lossless procedure that converts a sequence of discrete latent symbols (such as the quantized latent representation 412) into a compact, near-entropy-limited bit sequence, such as the bitstream 424. The arithmetic encoder 422 consumes probabilities or probability ranges supplied by an entropy model 428 432 and progressively refines ta numeric interval to represent the entire symbol sequence as a single fractional value, which is then emitted as bits. When combined with accurate entropy estimates, arithmetic encoding approaches the theoretical lower bound on average code length, improving compression efficiency over simpler prefix codes.

The bitstream 424 is the serialized sequence of bits produced by the arithmetic encoder 422 and is the physical artifact that is stored or transmitted. If well-formed, the bitstream 424 contains the encoded symbol information and any necessary metadata, such as model identifiers, headers describing quantization parameters, and synchronization markers. The bitstream 424 should be self-consistent and carry sufficient side information for the decoder 430 to reconstruct the image 402.

The entropy model 428 provides probability estimates for each discrete latent symbol conditioned on any available context, such as previously decoded symbols, side information, or learned priors. The entropy model 428 supplies symbol probabilities to the arithmetic encoder 422 to allocate interval mass efficiently during encoding and provides the same probabilities to the decoder 430 to correctly invert the arithmetic coding process. The effectiveness of the entropy model 428 determines how close the realized bit-rate is to the true content of the latent representation 412. As such, improving the entropy model 428 yields measurable gains in compression performance.

The arithmetic decoder 426 functions as the inverse of the arithmetic encoder 422. Given the bitstream 424 and the same entropy model 428, the arithmetic decoder 426 incrementally maps the fractional numeric representation back into the original sequence of discrete latent symbols. Correct arithmetic decoding relies on strict agreement between the arithmetic encoder 422 and the arithmetic decoder 426 on the entropy model 428, symbol alphabet, and any side information. Mismatches produce decoding errors. The arithmetic decoder 426 also handles implementation details, such as precision limits and underflow/overflow management, to ensure bit-exact recover of the encoded symbols.

The decoder 430 maps the recovered discrete latents back to the observation domain to produce the reconstructed image 402. The decoder 430 may perform a learned inverse mapping that accounts for quantization effects and any stochasticity. Additionally or alternatively, the decoder 430 may combine deterministic upsamples and synthesis modules tuned for minimal reconstruction error. The capacity of the decoder 430 determine reconstruction quality for a given bitrate and the interaction of the decoder 430 with the encoder, the quantization portion 420, and the entropy model 428 defines the overall rate-distortion characteristics of the LIC architecture 400.

In other words, the encoder 410 transforms an image 402 into a latent representation 412. This latent representation 412 is then quantized, entropy coded, and transmitted to the decoder 430, which employs an entropy model 428 to estimate the distribution of the latent variables. The decoder 430 decodes and dequantizes the bitstream 424 and reconstructs the image 402 from the latent representation 412. The training objective is to minimize both the bitstream 424 length and the reconstruction distortion, denoted by L=R+λD. A scaling factor (λ) is introduced to trade off bitrate and distortion based on server-side bitrate requirements. Distortion may be measured using, for example, mean-squared error (MSE) or multi-scale structural similarity (MS-SSIM). Achieving short bitstreams 440 typically utilizes effective analysis/synthesis transforms, accurate probability modeling of the latent representation, and differentiable approximations or relaxations of quantization.

Some approaches report performance superior to JPEG but inferior to H.265/HEVC intra-frame coding. Suppose the image 402 size is W×H, where W and H denote width and height, respectively. Feature extraction in the encoder 410 commonly uses downsampling stages, such as four downsampling layers or stages. The image 402 is downsampled, for example, by a factor of two at each stage while increasing the number of feature channels. The resulting latent representation contains multiple channels N_{c}×W/16×H/16), with the total number of channels denoted by N_{c}.

The LIC architecture 400 includes a hypothesis analysis and synthesis portion coupled to receive the latent representation 412 from the encoder 410. The hypothesis analysis synthesis portion includes a hyper encoder 440, a quantization portion 450, an arithmetic encoder 452, an arithmetic decoder 456, and a hyper decoder 460. The arithmetic encoder 452 and the arithmetic decoder 456 are coupled to an entropy model 458. The hypothesis analysis and synthesis portion is configured to provide side information to the arithmetic encoder 422 and the arithmetic decoder 426 (such as to a main entropy model 428) for arithmetic encoding and decoding, respectively.

The hypothesis analysis and synthesis portion is configured to produce a compact side representation that summarizes uncertainty and context needed to parameterize the primary entropy model. The hyper encoder 440 receives the latent representation 412 and generates the hypothesis 442, which is a set of coarse latent features that capture spatially-varying statistics, such as local scale, variance, or mixture weights. The hyper encoder 440 is trained jointly with the rest of the LIC architecture 400 so that its outputs provide the entropy model with signals the reduce mismatch between predicted and actual symbol distributions. To do so, however, the hyper encoder 440 trades off the additional side information rate against the improvement in main latent compressibility. The architecture of the hyper encoder 440 (convolutions, downsampling, receptive field) determines the granularity and range of context made available to the entropy model.

The quantization portion 450 of the hypothesis analysis and synthesis portion converts the hypothesis 442 into discrete symbols that can be losslessly encoded and later used to reconstruct the entropy model parameters. During training, differentiable approximations to quantization (such as noise injection, soft rounding, or straight-through estimators) allow gradients to flow so the hyper encoder 440 learns to produce hypothesis values that are both compact under quantization and maximally informative for the entropy model. The quantized hypothesis values form the alphabet over which arithmetic encoding in an arithmetic encoder 452 is applied. The architecture of the quantization portion 450 (such as uniform scalar, learned vector quantizer, or codebook) affects how well the hyperlatent distribution can be predicted by the hyperprior and, therefore, how efficiently the side information itself can be compressed.

The arithmetic encoder 452 converts the sequence of quantized hyperlatent symbols into a tightly packed bitstream 454 according to probability estimates supplied by a hyperprior entropy model. Because the hypothesis analysis and synthesis portion is intended to improve the main entropy model 428, the hyper encoder 440 and the quantization portion 450 must also be supported by their own entropy model 458, such as a fully factorized or autoregressive model configured to match the hyperlatent distribution, so the arithmetic encoding approaches the per-symbol entropy lower bound. The arithmetic encoder 452 therefore relies on accurate probability mass assignments for each hyper-symbol and any systematic bias in those assignments directly increases the bit cots of the side information and diminishes the net gain from hypothesis conditioning.

The bitstream 454 produce by the arithmetic encoder 452 interleaves or concatenates side information and main latent codes in a suitable form for storage or transmission. The hypothesis analysis and synthesis portion should consider how much side information the bitstream 454 will carry as the decoder 430 must be able to extract and decode the hyperlatents before attempting to decode the primary latents that depend on them. The bitstream 454 format is arranged to preserve this causal ordering and to include synchronization points that the arithmetic decoder 456 and the hyper decoder 460 expect.

The arithmetic decoder 456 is the deterministic inverse of the arithmetic encoder 452 and reconstructs the discrete hyperlatents from the bitstream 454 using the same hyperprior probabilities used during hyper encoding.

The hyper decoder 460, the synthesis stage of the hypothesis, maps the decoded discrete hyperlatents back into continuous parameter fields that condition the main entropy model 428, for example, by introducing spatial maps of scale, means, component weights, distributions, or context vectors used by autoregressive predictors. The side information 462 output of the hyper encoder 440 refines the prior or conditional distribution used to predict each primary latent symbol, enabling a far more accurate entropy model than a fixed, global prior.

The second generation of approaches introduce learning-based context generation, such as hypothesis analysis and hypothesis synthesis for arithmetic encoding and decoding of the latent-space representation. The hypothesis analysis and hypothesis synthesis transmits additional side information, referred to as hyper-priors, to the arithmetic encoder 422 and the arithmetic decoder 44560. Incorporating the generated hyper priors delivers about a 15% to about 20% improvement in compression performance compared with H.265/HEVC intra-frame coding.

The LIC architecture 400 also includes a context model 470, which replaces the entropy model 428 of the LIC architecture 400. The context model 470 is a learned conditional prior that predicts the discrete probability distribution of each latent symbol by fusing multiple complementary sources of context, such as a hyperprior (global coarse statistics), local spatial neighborhoods, and previously decoded channel or slice references, so that arithmetic coding may operate on tightly conditioned, slice-level distributions and approach the conditional entropy bound.

The context model 470 may include a context layers (not shown) configured to capture the channel-wise context from slices of the quantized latent representation 412, for example, using convolution layers to select the most relevant channels and extract information to improve probability estimation. The context model 470 may include other layers, such as attention layers, configured to capture local spatial correlations and other layers configured to aggregate global and local information within the same decode slice so that cross-slice correlations and residual dependencies are exploited to reduce uncertainty.

The context model 470 outputs to an entropy parameter module 480 which also receives the side information 462 from the hyper decoder 460. The entropy parameter module 480 is a neural subnetwork that consumes fused contextual signals, including hyperprior outputs, intra-slice global context, inter-slice references, and local neighborhood features, and maps them (via an output 482) to the per-symbol parameters of the predictive probability distribution used by the arithmetic encoder 422 and the arithmetic decoder 426.

Some learned image compression approaches employ more advanced feature analysis and feature synthesis methods to enhance coding performance, for example, by using residual networks, transformers, or hybrid transformer-residual architectures to replace other CNN models. Other approaches focus on optimizing the entropy model to further reduce redundancy in the latent representation.

End-to-end learned image compression has attracted significant attention due to its promising progress and superior rate-distortion performance. Advanced AI technologies, such as ResNet-based models, are evolving rapidly. Although CNNs and residual networks are widely used for feature analysis/hyper-analysis and synthesis/hyper-synthesis modules, in certain embodiments the present disclosure optimizes these modules with advanced AI tools to further improve compression performance.

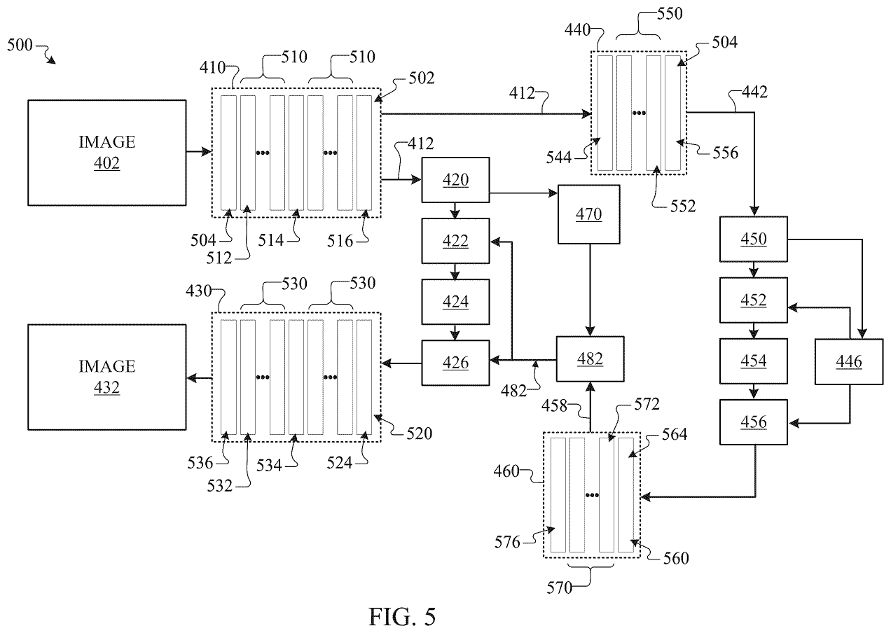

Although FIG. 4 illustrate examples of the learned image compression architecture 400, various changes may be made to FIG. 4. For example, various components of FIG. 4 could be combined, further subdivided, or omitted and additional components could be added according to particular needs. Additionally, the learned image compression architecture 400 may include ResNet layers as shown in FIG. 5.

FIG. 5 illustrates an example LIC architecture 500 according to embodiments of the present disclosure. For ease of explanation, the LIC architecture 500 will be described as including one or more components of the communication network 100 of FIG. 1, such as the client devices 106 116; however, the LIC architecture 500 could be implemented using any other suitable device or system. The embodiment of the LIC architecture 500 shown in FIG. 5 is for illustration only. Other embodiments of the LIC architecture 500 could be used without departing from the scope of this disclosure. The LIC architecture 500 is configured similarly to the LIC architecture 400 of FIG. 4, except as otherwise described.

As shown in FIG. 5, the LIC architecture 500 includes encoder layers 502 configured to receive and encode the image 402. The encoder layers 502 include a residual downsampling layer 504, multiple ResNet ladders 510 having multiple residual layers 512 coupled to a DWTF layer 514, and a convolution layer 516. Similarly, the LIC architecture 500 includes decoder layers 520. The decoder layers 520 include a residual upsampling layer 524, multiple ResNet ladders 530 having multiple residual layer 532 coupled to a DWTF layer 534, and a convolution layer 536.

For the hypothesis analysis and synthesis portion of the LIC architecture 500, the hyper encoder 460 includes hyper encoder layers 540. The hyper encoder layers 540 includes a residual downsampling layer 544, multiple ResNet ladders 550 having multiple residual layers 552 coupled to a convolution layer 556. Additionally, the LIC architecture 500 includes 560. The hyper decoder layers 560 include a residual upsampling layer 564, multiple ResNet ladders 570 having multiple residual layer 572 coupled to a convolution layer 576.

The LIC architecture 500 includes embodiments of the analysis, hyper-analysis, hyper-synthesis, and synthesis transformation network that incorporate ResNet ladders (such as the ResNet ladders 510) and DWTF layers (such as the DWTF layer 514). For example, the analysis and synthesis transformation sub-networks, including the encoder 410 and the decoder 430, may each include three ResNet ladders 510, 530, and the hyper-analysis and hyper-synthesis sub-networks, including the hyper encoder 440, and the hyper decoder 460, each include one ResNet ladder 550, 570. Within each ResNet ladder, there may be three residual blocks or layers.

In one embodiment, the spatial dimensions of the latent representation 412 are down-sampled by a factor of 16 within the encoder 410 starting from the input. The hyper-encoder 410 further down-samples by a factor of four while applying the hyper-analysis transformation. The hyper-synthesis and synthesis networks (such as the hyper decoder 460 and the decoder 430, respectively) reverse this process by up-sampling by the corresponding factors. The analysis and hyper-analysis transformations also vary the number of channels as the data is transformed and propagates through the network. For example, in one embodiment, the channel dimensions progress according to a specified configuration.

While none of the residual layers in the ResNet ladders 510 perform up-sampling or down-sampling, in one embodiment, the DWTF layers (such as the DWTF layer 514 and the DWTF layer 534) implement down-sampling by a factor of two in the analysis and hyper-analysis transformation blocks and implement up-sampling by a factor of two in the hyper-synthesis and synthesis transformation blocks. The LIC architecture 500 places residual layers as the first layer in the analysis and synthesis transformation blocks (such as the residual downsampling layer 504 and the residual upsampling layer 524); these layers perform down-sampling and up-sampling, respectively, by a factor of two. The final layers of all transformation blocks, including the analysis, hyper-analysis, hyper-synthesis, and synthesis transformation blocks, may be two-dimensional (2D) convolutional layers with a 3×3 kernel. In the encoder 410 and hyper encoder 440, these convolutional layers perform down-sampling by a factor of two, whereas in the hyper decoder 460 and the decoder 430, they perform up-sampling by a factor of two.

The LIC architecture 500 includes DWTF layers (such as the DWTF layer 514 and the DWTF layer 534) positioned between the ResNet ladders in both the encoder 410 and the decoder 430. The hyper encoder 440 and the hyper decoder 460 perform one or multi-level 2D wavelet transformations that decompose spatial features into wavelet coefficients across four sub-bands at each level, apply learned convolutional filtering to these coefficients at each level, and then apply inverse wavelet transformations to reconstruct spatial features after attenuating correlations and removing less important features. Although the wavelet transform coefficients are fixed by the selected wavelet family, the convolutional filtering coefficients, which determine which transformation coefficients are less important and therefore pruned, are learned during end-to-end rate-distortion optimization.

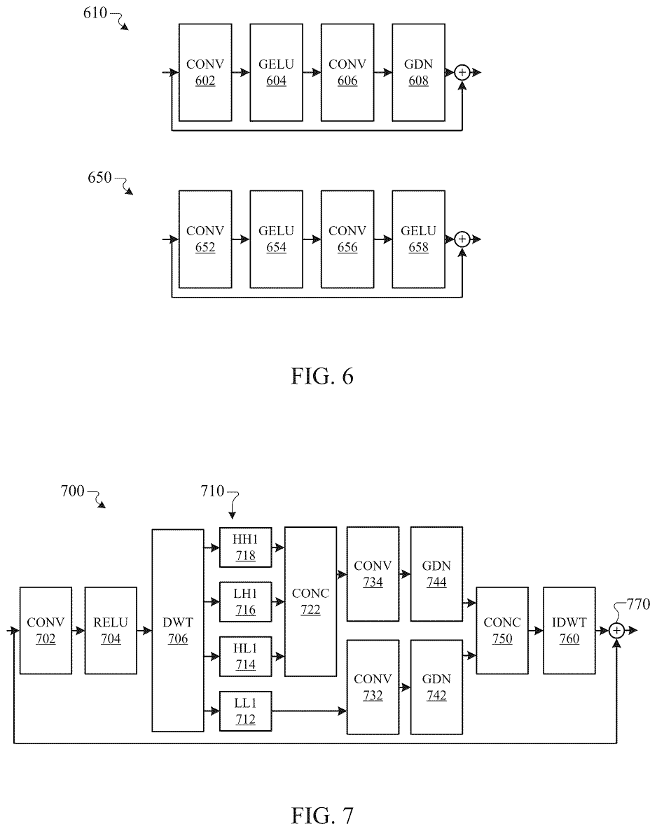

Although FIG. 5 illustrates one example of an LIC architecture 500, various changes may be made to FIG. 5. For example, various components of FIG. 5 could be combined, further subdivided, or omitted and additional components could be added according to particular needs. Additionally, the LIC architecture 500 may include residual layers as shown in FIG. 6.

FIG. 6 illustrates example residual layers 600, 650 according to embodiments of the present disclosure. For ease of explanation, the residual layers 600, 650 will be described as including one or more components of the communication network 100 of FIG. 1, such as the client devices 106 116; however, the residual layers 600, 650 could be implemented using any other suitable device or system. The embodiment of the residual layers 600, 650 shown in FIG. 6 is for illustration only. Other embodiments of the residual layers 600, 650 could be used without departing from the scope of this disclosure.

As shown in FIG. 6, the residual layer 600 includes a convolution sampling layer 602 that provides a convolution (either by upsampling or downsampling, depending on whether the residual layer 600 is incorporated with an encoder or decoder) of an input to a Gaussian Error Linear Unit 604 for activation. The convolution sampling layer 602 extracts spatial features from the input. The GELU activation layer 604 introduces non-linearity, enhancing the capacity of the residual layer 600 to model complex relationships. Once activated, the GELU activation layer 604 outputs to a convolution layer 606 before processing in a normalization layer 608. The residual layer 600 may optionally include pooling layers to downsample (or upsample) feature maps, reducing computational load and spatial dimensions. The normalization layer 608 stabilizes and accelerates training by normalizing activations. The normalization layer 608 generates an output that is combined with the input as part of a skip connection. The skip connection allows the input to bypass one or more layers. When combined with the output of the residual block, the input is directly added to the output, preserving essential features and enabling efficient gradient propagation. The residual layer600 map the learned features to output classes or latent vectors. Similarly, the residual layer 650 includes a first convolution layer 652, a first GELU activation layer 654, and a second convolution layer 656. However, the second convolution layer 656 outputs to a second GELU activation layer 658 to produce an output that is combined with the input.

For both residual layers 600, 650 shown in FIG. 6, the convolution operation is applied in the skip (residual) path to align tensor dimensions for element-wise addition is not shown. Additionally or alternatively, the GELU activation layers 604, 654, 658 may be replaced by other suitable activation functions, such as Generalized Divisive Normalization (GDN) and Inverse Generalized Divisive Normalization (IGDN) activation functions.

The residual layers 600, 650 function as residual network (ResNet) layers to enhance feature extraction and reconstruction by enabling deeper networks with stable gradient flow and reduce parameter complexity. The residual layers 600, 650 are built upon residual learning where the residual layers 600, 650 learn a residual function rather than direct mapping, allowing the residual layers 600, 650 to preserve low-level features across layers and mitigates vanishing gradient issues. The residual layers 600, 650 may be embedded in the encoder 410, the decoder 430, the hyper encoder 440, the hyper decoder 460, or a combination thereof. In the encoder 410, for example, the residual layers 600, 650 aid in capturing hierarchical features while reducing redundancy. In the decoder 430, for example, the residual layers 600, 650 assist in restructuring high-quality images from compressed latent representations.

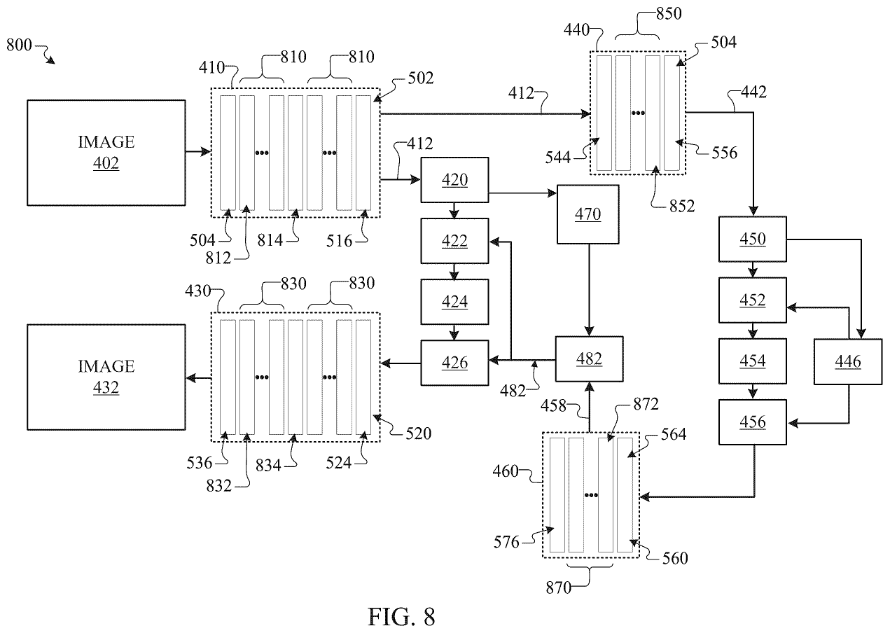

Although FIG. 6 illustrates examples residual layers 600, 650, various changes may be made to FIG. 6. For example, various components of FIG. 6 could be combined, further subdivided, or omitted and additional components could be added according to particular needs. Additionally, the LIC architecture 500 may include discrete wavelet transform filters as shown in FIG. 7.

FIG. 7 illustrates an example discrete wavelet transform filter 700 according to embodiments of the present disclosure. For ease of explanation, the discrete wavelet transform filter 700 will be described as including one or more components of the communication network 100 of FIG. 1, such as the client devices 106 116; however, the discrete wavelet transform filter 700 could be implemented using any other suitable device or system. The embodiment of the discrete wavelet transform filter 700 shown in FIG. 7 is for illustration only. Other embodiments of the discrete wavelet transform filter 700 could be used without departing from the scope of this disclosure.

As shown in FIG. 7, the DWTF architecture 700 includes a convolution sampling layer 702 coupled to a ReLU activation layer 704 and to a Discrete Wavelet Transform (DWT) 706. The DWT 706 provides input to wavelet coefficients 710, such as a first coefficient 712, a second coefficient 714, a third coefficient 716, and a fourth coefficient 718. The first coefficient 712 outputs to a first convolution layer 732 while the second coefficient 714, the third coefficient 716, and the fourth coefficient 718 output to a first concatenation layer 722 and, subsequently, a second convolution layer 734. Each of the first convolution layer 732 and the second convolution layer 734 are coupled to an activation function, such as a first GDN 742 and a second GDN 744, respectively. The first GDN 742 and the second GDN 744 output to a second concatenation layer 750 for combination then to an Inverse Discrete Wavelet Transform (IDWT) 760. The output of the IDWT 760 is then combined with the original input using a sum function 770.

The DWTF architecture 700 is configured for multi-resolution analysis by decomposing images into frequency sub-bands. The DWTF architecture 700 operates through filter banks that include low-pass and high-pass filters. The low-pass filter captures coarse image features, while the high-pass filter isolates fine details, such as edges or textures. When applied in two dimensions (such as row-wised and column-wise), the DWTF architecture 700 produces four sub-bands: an approximation (LL), horizontal details (LH), vertical details (HL), and diagonal details (HH). This decomposition facilitates energy compaction as most image energy resides in the LL sub-band, which can be encoded more efficiently. The high-frequency sub-bands (LH, HL, and HH) are well-suited for entropy encoding.

As shown in FIG. 7, the first layer in the DWFT architecture 700 is a convolutional layer 702 that upsamples or downsamples an input feature tensor followed by an activation layer, such as the ReLU layer 704, that generates a feature map. The resulting feature map is then transformed into the wavelet domain by the DWT 706. The wavelet coefficients 710 in the low-frequency LL sub-band, such as the first coefficient 712, are filtered by the first convolution layer 732 while the coefficients in the high-frequency HL, LH, and HH sub-bands (such as the second coefficient 714, the third coefficient 716, and the fourth coefficient 718) are concatenated in the first concatenation layer 722 and filtered by the second convolution layer 734. The filtered coefficients, following application of GDN activation in the first GDN 742 and the second GDN 744, are concatenated in the second concatenation layer 750 and the IDWT 760 is applied to convert the features from the wavelet domain back to the spatial domain. In parallel with this main path, the DWTF layer includes a skip (residual) connection, analogous to the residual layers, that is combined using the sum function 770.

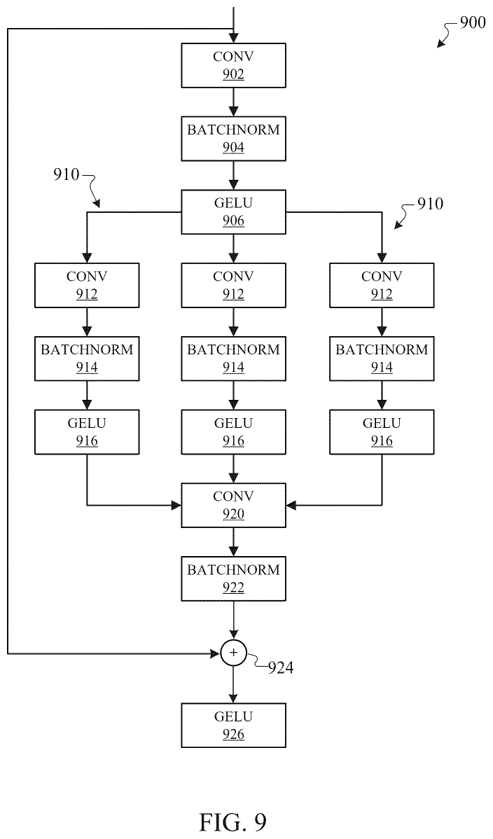

Although FIG. 7 illustrates one example of a discrete wavelet transform filter 700, various changes may be made to FIG. 7. For example, various components of FIG. 7 could be combined, further subdivided, or omitted and additional components could be added according to particular needs. Additionally, the LIC architecture 500 may be modified to include residual networks with external transformations (ResNeXt) layers and wavelet ResNeXt (WaveResNeXt) layers as shown in FIG. 8.

FIG. 8 illustrates an example LIC architecture 800 according to embodiments of the present disclosure. For ease of explanation, the LIC architecture 800 will be described as including one or more components of the communication network 100 of FIG. 1, such as the client devices 106 116; however, the LIC architecture 800 could be implemented using any other suitable device or system. The embodiment of the LIC architecture 800 shown in FIG. 8 is for illustration only. Other embodiments of the LIC architecture 800 could be used without departing from the scope of this disclosure. The LIC architecture 800 is configured similarly to the LIC architectures 400, 500 of FIGS. 4 and 5, except as otherwise described.

As shown in FIG. 8, the LIC architecture 800 includes multiple ResNeXt ladders 810 in the encoder 410. In particular, the multiple ResNeXt ladders 810 includes ResNeXt layers 812 and, rather than the DWTF layer 514, the ResNeXt layers 812 are coupled to a WaveResNeXt layer 814. Similarly, the decoder 430 includes multiple ResNeXt ladders 830 having ResNeXt layers 832 coupled to a WaveResNeXt layer 834. The hyper encoder 440 includes multiple ResNeXt ladders 850 having ResNeXt layers 852. The hyper decoder 460 includes multiple ResNeXt ladders 870 having ResNeXt layers 872.

In other words, in the LIC architecture 800, the ResNet ladders (such as the multiple ResNet ladders 510, the multiple ResNet ladders 530, the multiple ResNet ladders 550, and the multiple ResNet ladders 570) are replaced with ResNeXt ladders built from ResNeXt layers rather than ResNet layers, and the DWTF layers are replaced with WaveResNeXt layers.

The ResNeXt layers (such as the ResNeXt layers 812 in the encoder 410), are convolutional neural networks designed to enhance the representational power of deep networks while maintaining computational efficiency. The ResNeXt layers include residual learning with multi-path feature extraction to introduce cardinality. The WaveResNeXt layers are similar to the ResNeXt layers, except the WaveResNeXt layers include wavelet processing similar to the DWTF architecture of FIG. 7.

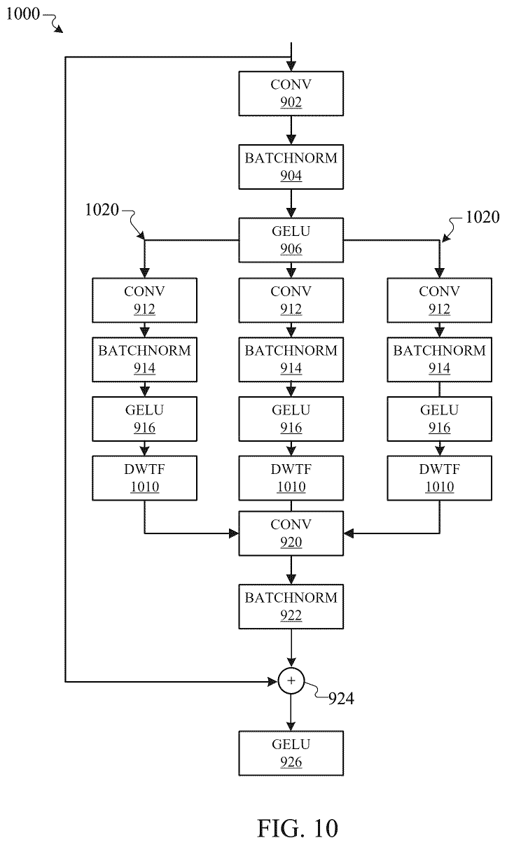

Although FIG. 8 illustrates one example of an LIC architecture 800, various changes may be made to FIG. 8. For example, various components of FIG. 8 could be combined, further subdivided, or omitted and additional components could be added according to particular needs. Additionally, the ResNeXt layers may include the layer architecture shown in FIG. 9.

FIG. 9 illustrates an example ResNeXt layer 900 according to embodiments of the present disclosure. For ease of explanation, the ResNeXt layer 900 will be described as including one or more components of the communication network 100 of FIG. 1, such as the client devices 106 116; however, the ResNeXt layer 900 could be implemented using any other suitable device or system. The embodiment of the ResNeXt layer 900 shown in FIG. 9 is for illustration only. Other embodiments of the ResNeXt layer 900 could be used without departing from the scope of this disclosure.

As shown in FIG. 9, the ResNeXt layer 900 includes a first convolution layer 902, such as a 1×1 convolution, coupled to a first batch normalization layer 904 and an activation function, such as a first GELU activation layer 906. The first GELU activation layer 906 then outputs to multiple channel-wise parallel paths 910. Each of the multiple channel-wise parallel paths 910 includes a channel convolution layer 912, a channel batch normalization layer 914, and a channel GELU activation layer 916. The channel-wise parallel paths 910 each produce an output that is convoluted in a second convolution layer 920 before being processed in a second batch normalization layer 922. The output of the second batch normalization layer 922 is combined with a skip connection at a sum function 924 before activation at an output GELU activation layer 926.

As mentioned above, the ResNeXt layer 900 includes residual learning with multi-path feature extraction to introduce cardinality, which refers to the number of parallel transformations or paths in a residual block. Rather than increasing depth or width to improve performance as in a ResNet architecture, the ResNeXt layer 900 may increase cardinality to improve performance, allowing for a more scalable and modular design.

After a one-by-one (1×1) convolution in the first convolution layer 902, batch normalization in the first batch normalization layer 904, and activation by the first GELU activation layer 906, the channels are partitioned into multiple parallel channel-wise parallel paths 910, where the number of paths is equal to the cardinality. Each of the parallel channel-wise parallel paths 910 perform a transformation on a subset of the input channels. The features in each path undergo convolutional filtering, batch normalization, and a GELU activation in parallel in the channel convolution layer 912, the channel batch normalization layer 914, and the channel GELU activation layer 916, respectively. The outputs from all paths are then aggregated (such as by concatenation) and passed through an additional 1×1 convolution in the second convolution layer 920 and batch normalization in the second batch normalization layer 922. The output of the second batch normalization layer 922 is then added to the residual via the skip connection using the sum function 924. Additionally, the combined output undergoes activation in the output GELU activation layer 926. The grouped convolution architecture allows the ResNeXt layer 900 to maintain the same number of parameters and computation complexity as a similar-sized ResNet while significantly improving accuracy. The bandwidth parameter governs the number of channels used in each convolution within the split paths.

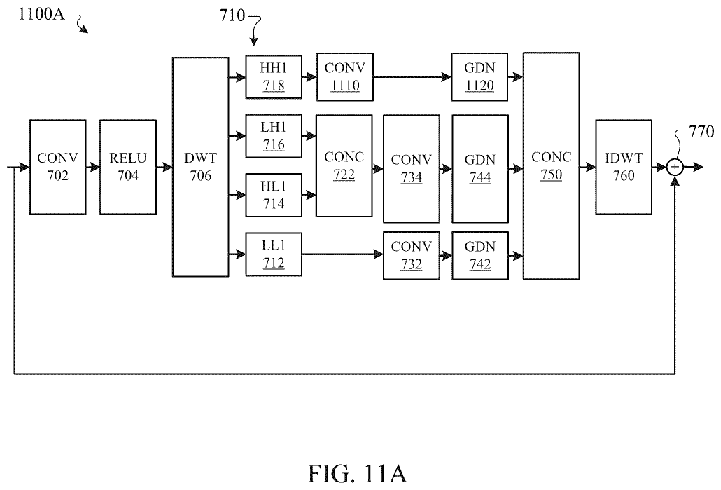

Although FIG. 9 illustrates one example of an ResNeXt layer 900, various changes may be made to FIG. 9. For example, various components of FIG. 9 could be combined, further subdivided, or omitted and additional components could be added according to particular needs. Additionally, the WaveResNeXt layers in the LIC architecture 800 may include the layer architecture shown in FIG. 10.

FIG. 10 illustrates an example WaveResNeXt layer 1000 according to embodiments of the present disclosure. For ease of explanation, the WaveResNeXt layer 1000 will be described as including one or more components of the communication network 100 of FIG. 1, such as the client devices 106 116; however, the WaveResNeXt layer 1000 could be implemented using any other suitable device or system. The embodiment of the WaveResNeXt layer 1000 shown in FIG. 10 is for illustration only. Other embodiments of the WaveResNeXt layer 1000 could be used without departing from the scope of this disclosure. The WaveResNeXt layer 1000 is configured similarly to the ResNeXt architecture 900 of FIG. 9 except as otherwise described.

As shown in FIG. 10, the WaveResNeXt layer 1000 includes one or more wavelet transform parallel layers 1010 in each of the channel-wise parallel paths 910, making parallel wavelet transforms paths 1020. The one or more wavelet transform parallel layers 1010 may be coupled to a final activation function of the channel, such as the channel GELU activation layer 916, to provide filtering. The one or more wavelet transform parallel layers 1010 may include a wavelet filtering architecture, such as the DWTF architecture of FIG. 7 described above.

In essence, the WaveResNeXt architecture 1000 adds a DWTF block (such as the one or more wavelet transform parallel layers 1010) to each split path of the ResNeXt block (such as the channel-wise parallel paths 910). This allows the WaveResNeXt architecture 1000 to augment the grouped convolution operations with wavelet-based decomposition to capture multi-scale frequency information on a channel-wise basis. Such a channel-wise decomposition allows the WaveResNeXt architecture 1000 to improve accuracy and enhance energy compaction. Compared to the ResNet-and DWTF-based architectures (FIGS. 6 and 7), the ResNeXt-and WaveResNeXt-based LIC architecture (such as the LIC architecture 800) uses approximately 40% fewer parameters and, thus, requires less computational power to produce accurate results.

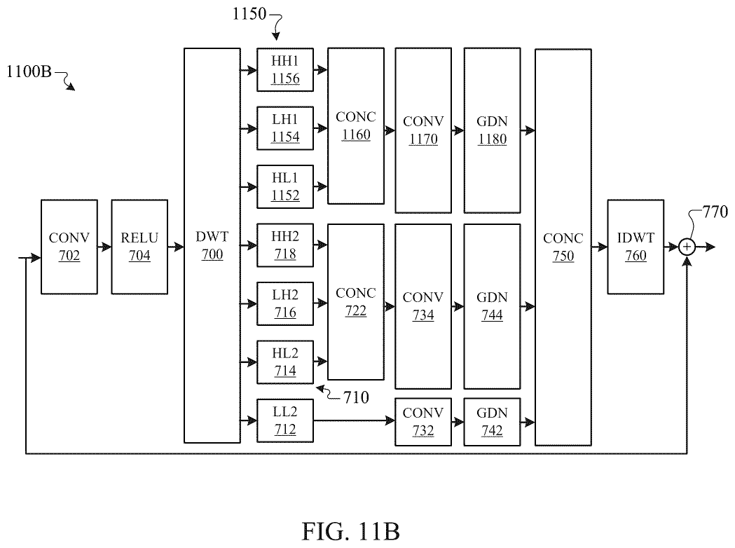

Although FIG. 10 illustrates one example of a WaveResNeXt layer 1000, various changes may be made to FIG. 10. For example, various components of FIG. 10 could be combined, further subdivided, or omitted and additional components could be added according to particular needs. Additionally, the LIC architecture 800 may include as shown in FIGS. 11A-11B.

FIGS. 11A-11B illustrates an example discrete wavelet transform layers 1100A, 1100B according to embodiments of the present disclosure. For ease of explanation, the discrete wavelet transform layers 1100A, 1100B will be described as including one or more components of the communication network 100 of FIG. 1, such as the client devices 106 116; however, the discrete wavelet transform layers 1100A, 1100B could be implemented using any other suitable device or system. The embodiment of the discrete wavelet transform layers 1100A, 1100B shown in FIGS. 11A-11B is for illustration only. Other embodiments of the discrete wavelet transform layers 1100A, 1100B could be used without departing from the scope of this disclosure. Each of the discrete wavelet transform layers 1100A, 1100B are configured similarly to the DWTF architecture 700.

As shown in FIG. 11A, the discrete wavelet transform layers 1100A includes a third convolution layer 1110 coupled to the fourth coefficient 718, separate from the other wavelet coefficients 710. The third convolution layer 1110 is coupled to a third GDN 1120 such that the third convolution layer 1110 outputs directly into the third GDN 1120. The output of the third GDN 1120 is concatenated with the output of the first GDN 742 and the second GDN 744 in the second concatenation layer 750.

The distinction between this DWTF block and the configuration in FIG. 7 is that the HH1 sub-band, like the LL1 sub-band, is convolved separately from the concatenated HL1 and LH1 sub-bands.

FIG. 11B illustrates an additional alternative architecture for the DWTF block employing a two-level DWT. As show in FIG. 11B, the discrete wavelet transform layers 1100B includes additional wavelet coefficients 1150, such as a first coefficient 1152, a second coefficient 1154, and a third coefficient 1156, coupled to output to a third concatenation layer 1160 that concatenates the additional wavelet coefficients 1150 separately, but concurrently, with the concatenation of the wavelet coefficients 710 in the first concatenation layer 722.

Similarly, the concatenated coefficients are convoluted in a third convolution layer 1170, separately and concurrently to the convolution in the first convolution layer 732 and the second convolution layer 734, before activation in a third GDN 1180 and subsequent concatenation in the second concatenation layer 750.

Although FIGS. 11A-11B illustrates example discrete wavelet transform layers 1100A, 1100B, various changes may be made to FIGS. 11A-11B. For example, various components of FIGS. 11A-11B could be combined, further subdivided, or omitted and additional components could be added according to particular needs.

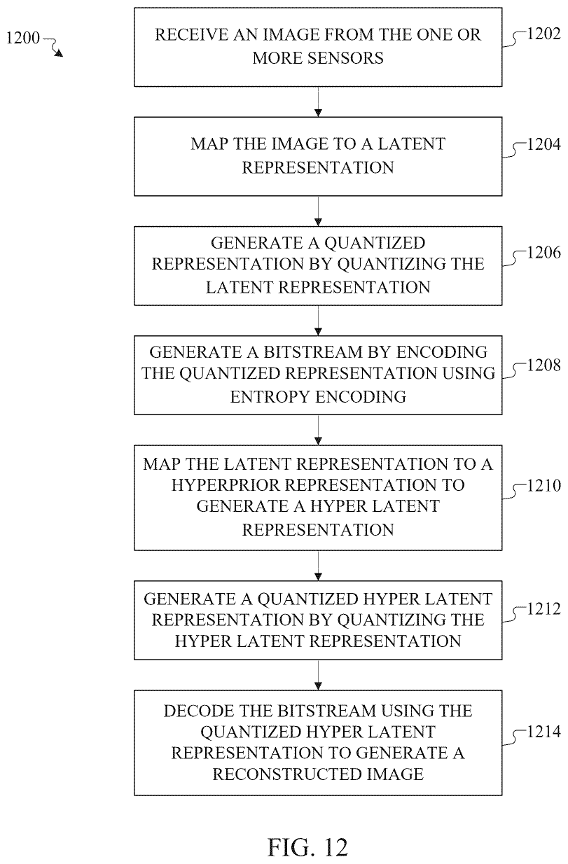

FIG. 12 illustrates an example method 1200 for learned image compression using a WaveResNeXt architecture according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of learned image compression using a WaveResNeXt architecture could be used without departing from the scope of this disclosure.

As shown in FIG. 12, an image is received from one or more sensors at step 1202. For example, one or more optical sensors or cameras of the electronic device 300 may obtain an image 702 and provide the image 702 to the LIC architecture 800.

The image is mapped to a latent representation using an encoder with parallel processing layers at step 1204. For example, the encoder 410 of the LIC pipeline 800 receives an image 402 and maps the image 402 to a latent representation 412. Each of the parallel processing layers, such as the ResNeXt ladders 810, may include GELU activation layers 906 and channel-wise parallel paths 910 coupled after the GELU activation layers 906. The encoder further may include one or more wavelet transform layers 1010 coupled in series to one or more of the parallel processing layers, such as the ResNeXt ladders 810. Each of the one or more wavelet transform layers 1010 may include a discrete wavelet transformation filter layer 1010. A concatenation layer may be coupled at an end of each of the channel-wise parallel paths 910 and configured to combine outputs of the channel-wise parallel paths 910.

A quantized representation is generated by quantizing the latent representation at step 1206. For example, the quantization portion 420 receives the latent representation 412 and quantizes the latent representation 412 to generate a quantized representation.

A bitstream is generated by encoding the quantized representation using entropy encoding at step 1208. For example, the arithmetic encoder 422 receives input from an entropy parameter module 480 and generates a bitstream 424 based on the quantized representation and input from the entropy parameter module 480.

The latent representation is mapped to a hyperprior representation to generate a hyper latent representation at step 1210. For example, the encoder 410 also provides the latent representation 412 to a hyper encoder 440 to generate a hyper latent representation. The hyper encoder 440 may include the parallel processing layers, such as the ResNeXt layers 850.

A quantized hyper latent representation is generated by quantizing the hyper latent representation at step 1212. For example, the hyper latent representation is provided to a quantization portion 460 that quantizes the hyper latent representation to generate a quantized hyper latent representation. The quantized hyper latent representation to an arithmetic encoder 452. The arithmetic encoder 452 uses the quantized hyper latent representation and input from a factorized entropy model 446 to generate a bitstream 454. For example, the arithmetic encoder 452 may entropy encode the hyper latent representation to generate the bitstream 454. The bitstream 454 is provided to an arithmetic decoder 456, which also uses input from the factorized entropy model 446 to decode the bitstream 454. The arithmetic decoder 456 then provides the decoded bitstream 454 to a hyper decoder 460. The bitstream 454 may be decoded using a hyper decoder 460 having the parallel processing layers, such as the ResNeXt ladders 870.

The bitstream is decoded using the quantized hyper latent representation to generate a reconstructed image at step 1214. For example, the hyper decoder 460 provides an input 478 to generate an input 478 to the entropy parameter module 480. The input 478 updates the output provided by the entropy parameter module 480 to the arithmetic decoder 436, which updated the decoded bitstream 424. The decoder 430 then decodes the output from the arithmetic decoder 436 and generates a restructured image 482. The decoder 430 may include parallel processing layers, the ResNeXt ladders 830.

Although FIG. 12 illustrates one example method for learned image compression using a WaveResNeXt architecture, various changes may be made to FIG. 12. For example, while shown as a series of steps, various steps in FIG. 12 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
receiving an image;
mapping the image to a latent representation using an encoder with parallel processing layers;
generating a quantized representation by quantizing the latent representation using a hyper encoder;
generating a bitstream by encoding the quantized representation using entropy encoding;
mapping the latent representation to a hyperprior representation to generate a hyper latent representation;
generating a quantized hyper latent representation by quantizing the hyper latent representation; and
decoding the bitstream using a decoder based on the quantized hyper latent representation to generate a reconstructed image.

2. The method of claim 1, wherein each of the parallel processing layers comprise:
GELU activation layers; and
parallel paths coupled after the GELU activation layers, each of the parallel paths comprising:
a convolution layer;
a batch normalization layer; and
a second GELU activation layer.

3. The method of claim 2, wherein the encoder further comprises:
one or more wavelet transform parallel layers coupled in series to one or more of the parallel processing layers, each of the one or more wavelet transform parallel layers comprising:
GELU activation layers;
parallel wavelet transform paths coupled after the GELU activation layers, each of the parallel wavelet transform paths comprising:
a convolution layer;
a batch normalization layer;
a second GELU activation layer; and
a discrete wavelet transformation filter layer; and
a concatenation layer coupled at an end of each of the parallel paths and configured to combine outputs of the parallel paths.

4. The method of claim 2, wherein the discrete wavelet transformation filter layer comprises a two-level DWT filter or a filter layer that comprises:
a first coefficient;
a first convolution layer configured to receive the first coefficient and configured to output to a first activation layer;
a second coefficient;
a third coefficient;
a concatenation layer configured to concatenate the second coefficient and the third coefficient and provide the second and third coefficients to a second convolution layer, the second convolution layer configured to output to a second activation layer;
a fourth coefficient; and
a third convolution layer coupled to receive the fourth coefficient and configured to output to a third activation layer.

5. The method of claim 1, wherein the hyper encoder includes parallel processing layers comprising:
GELU activation layers;
parallel paths coupled after the GELU activation layers, each of the parallel paths comprising:
a convolution layer;
a batch normalization layer; and
a second GELU activation layer; and
a concatenation layer coupled at an end of each of the parallel paths and configured to combine outputs of the parallel paths.

6. The method of claim 1, wherein the decoder includes parallel processing layers comprising:
GELU activation layers;
parallel paths coupled after the GELU activation layers, each of the parallel paths comprising:
a convolution layer;
a batch normalization layer; and
a second GELU activation layer; and
a concatenation layer coupled at an end of each of the parallel paths and configured to combine outputs of the parallel paths.

7. The method of claim 6, wherein the decoder comprises:
one or more of the parallel processing layers coupled in series to one or more wavelet transform parallel layers, the one or more wavelet transform parallel layers comprising:
GELU activation layers;
parallel wavelet transform paths coupled after the GELU activation layers, each of the parallel wavelet transform paths comprising:
a convolution layer;
a batch normalization layer;
a second GELU activation layer; and
a discrete wavelet transformation filter layer; and
a concatenation layer coupled at an end of each of the parallel paths and configured to combine outputs of the parallel paths.

8. An electronic device, comprising:
memory;
a processor operably coupled to the memory, the processor configured to cause the electronic device to:
receive an image;
map the image to a latent representation using an encoder with parallel processing layers;
generate a quantized representation by quantizing the latent representation using a hyper encoder;
generate a bitstream by encoding the quantized representation using entropy encoding;
map the latent representation to a hyperprior representation to generate a hyper latent representation;
generate a quantized hyper latent representation by quantizing the hyper latent representation; and
decode the bitstream using a decoder based on the quantized hyper latent representation to generate a reconstructed image.

9. The electronic device of claim 8, wherein each of the parallel processing layers comprise:
GELU activation layers; and
parallel paths coupled after the GELU activation layers, each of the parallel paths comprising:
a convolution layer;
a batch normalization layer; and
a second GELU activation layer.

10. The electronic device of claim 9, wherein the encoder further comprises:
one or more wavelet transform parallel layers coupled in series to one or more of the parallel processing layers, each of the one or more wavelet transform parallel layers comprising:
GELU activation layers;
parallel wavelet transform paths coupled after the GELU activation layers, each of the parallel wavelet transform paths comprising:
a convolution layer;
a batch normalization layer;
a second GELU activation layer; and
a discrete wavelet transformation filter layer; and
a concatenation layer coupled at an end of each of the parallel paths and configured to combine outputs of the parallel paths.

11. The electronic device of claim 9, wherein the discrete wavelet transformation filter layer comprises a two-level DWT filter or a filter layer that comprises:
a first coefficient;
a first convolution layer configured to receive the first coefficient and configured to output to a first activation layer;
a second coefficient;
a third coefficient;
a concatenation layer configured to concatenate the second coefficient and the third coefficient and provide the second and third coefficients to a second convolution layer, the second convolution layer configured to output to a second activation layer;
a fourth coefficient; and
a third convolution layer coupled to receive the fourth coefficient and configured to output to a third activation layer.

12. The electronic device of claim 9, wherein the hyper encoder includes parallel processing layers comprising:
GELU activation layers;
parallel paths coupled after the GELU activation layers, each of the parallel paths comprising:
a convolution layer;
a batch normalization layer; and
a second GELU activation layer; and
a concatenation layer coupled at an end of each of the parallel paths and configured to combine outputs of the parallel paths.

13. The electronic device of claim 8, wherein the decoder includes parallel processing layers comprising:
GELU activation layers;
parallel paths coupled after the GELU activation layers, each of the parallel paths comprising:
a convolution layer;
a batch normalization layer; and
a second GELU activation layer; and
a concatenation layer coupled at an end of each of the parallel paths and configured to combine outputs of the parallel paths.

14. The electronic device of claim 13, wherein the decoder comprises:
one or more of the parallel processing layers coupled in series to one or more wavelet transform parallel layers, the one or more wavelet transform parallel layers comprising:
GELU activation layers;
parallel wavelet transform paths coupled after the GELU activation layers, each of the parallel wavelet transform paths comprising:
a convolution layer;
a batch normalization layer;
a second GELU activation layer; and
a discrete wavelet transformation filter layer; and
a concatenation layer coupled at an end of each of the parallel paths and configured to combine outputs of the parallel paths.

15. A non-transitory computer-readable medium comprising program code, that when executed by at least one processor of an electronic device, causes the electronic device to:
receive an image;
map the image to a latent representation using an encoder with parallel processing layers;
generate a quantized representation by quantizing the latent representation using a hyper encoder;
generate a bitstream by encoding the quantized representation using entropy encoding;
map the latent representation to a hyperprior representation to generate a hyper latent representation;
generate a quantized hyper latent representation by quantizing the hyper latent representation; and
decode the bitstream using a decoder based on the quantized hyper latent representation to generate a reconstructed image.

16. The non-transitory computer-readable medium of claim 15, wherein each of the parallel processing layers comprise:
GELU activation layers; and
parallel paths coupled after the GELU activation layers, each of the parallel paths comprising:
a convolution layer;
a batch normalization layer; and
a second GELU activation layer.

17. The non-transitory computer-readable medium of claim 16, wherein the encoder further comprises:
one or more wavelet transform parallel layers coupled in series to one or more of the parallel processing layers, each of the one or more wavelet transform parallel layers comprising:
GELU activation layers;
parallel wavelet transform paths coupled after the GELU activation layers, each of the parallel wavelet transform paths comprising:
a convolution layer;
a batch normalization layer;
a second GELU activation layer; and
a discrete wavelet transformation filter layer; and
a concatenation layer coupled at an end of each of the parallel paths and configured to combine outputs of the parallel paths.

18. The non-transitory computer-readable medium of claim 16, wherein the discrete wavelet transformation filter layer comprises a two-level DWT filter or a filter layer that comprises:
a first coefficient;
a first convolution layer configured to receive the first coefficient and configured to output to a first activation layer;
a second coefficient;
a third coefficient;
a concatenation layer configured to concatenate the second coefficient and the third coefficient and provide the second and third coefficients to a second convolution layer, the second convolution layer configured to output to a second activation layer;
a fourth coefficient; and
a third convolution layer coupled to receive the fourth coefficient and configured to output to a third activation layer.

19. The non-transitory computer-readable medium of claim 15, wherein the decoder includes parallel processing layers comprising:
GELU activation layers;
parallel paths coupled after the GELU activation layers, each of the parallel paths comprising:
a convolution layer;
a batch normalization layer; and
a second GELU activation layer; and
a concatenation layer coupled at an end of each of the parallel paths and configured to combine outputs of the parallel paths.

20. The non-transitory computer-readable medium of claim 19, wherein the decoder comprises:
one or more of the parallel processing layers coupled in series to one or more wavelet transform parallel layers, the one or more wavelet transform parallel layers comprising:
GELU activation layers;
parallel wavelet transform paths coupled after the GELU activation layers, each of the parallel wavelet transform paths comprising:
a convolution layer;
a batch normalization layer;
a second GELU activation layer; and
a discrete wavelet transformation filter layer; and
a concatenation layer coupled at an end of each of the parallel paths and configured to combine outputs of the parallel paths.
